(19) United States
(12) Patent Application Publication
(10) Pub. No.: US 2021/0080267 A1
(43) Pub. Date: Mar. 18, 2021

(54) Path Planning Method and Device for Unmanned Vehicle, and Computer Device

(71) Applicant: GUANGZHOU AUTOMOBILE GROUP CO., LTD., Guangzhou, Guangdong (CN)

(72) Inventors: Xinhua GAN, Guangzhou (CN); Hongshan ZHA, Guangzhou (CN); Ted S HUANG, Guangzhou (CN); Wei XU, Guangzhou (CN); Feng PEI, Guangzhou (CN); Caijing XIU, Guangzhou (CN)

(73) Assignee: Guangzhou Automobile Group Co., Ltd., Guangzhou, Guangdong (CN)

(21) Appl. No.: 16/488,948

(22) PCT Filed: Oct. 19, 2018
(86) PCT No.: PCT/CN2018/111084

§ 371 Date: Aug. 27, 2019

(30) Foreign Application Priority Data
Oct. 25, 2017 (CN) 201711016390.1

(51) Int. Cl. G01C 21/34; G01C 21/36; B60W 40/072

(52) U.S. Cl. CPC G01C 21/343; G01C 21/3617; B60W 2554/806; B60W 40/072; G01C 21/3602

(57) ABSTRACT

Provided are a path planning method and device for an unmanned vehicle, road segments of an origin and destination of a path are acquired; path search is performed to generate an initial path according to an exit endpoint of the road segment where the origin is located, an entrance endpoint of the road segment where the destination is located, and entrance endpoints and exit endpoints of the road segments for connecting the exit endpoint of the road, segment where the origin is located to the entrance endpoint of the road segment where the destination is located; an exit endpoint of a previous road section of the connecting passages in a passable direction is updated according to entrance endpoints of the connecting passages in the initial path; and a final planed path is generated according to different endpoints in the updated initial path.

### TECHNICAL FIELD

The present disclosure relates to the technical field of unmanned driving, and in particular, to a path planning method and device for an unmanned vehicle, a computer-readable storage medium, and a computer device.

### BACKGROUND

Path planning is one of the key technologies for driving vehicle research. When planning a path, it is generally a pure geometric path between an origin and a destination (also called a target point). At present, the path planning of vehicles is generally road-level planning, that is, planning a road from an origin to a destination. However, when driving a vehicle based on a path obtained after road-level planning, especially for unmanned vehicles, it is impossible to ensure that the unmanned vehicles obey traffic rules and are driven safely.

### SUMMARY

In view of this, it is necessary to provide, for the problem that a driving path generated in a traditional manner cannot ensure that a vehicle obeys traffic rules and is driven safely, a path planning method and device for an unmanned vehicle, a computer-readable storage medium, and a computer device.

According to an embodiment of the present disclosure, a path planning method for an unmanned vehicle is provided, which includes the following steps: a road segment where an origin of a path is located and a road segment where a destination of the path is located are acquired, the road segment including a road section and a connecting passage; a path search is performed to generate an initial path according to a connection relationship between endpoints of road segments, the endpoints of road segments including: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located; an exit endpoint of a previous road section of the connecting passages in a passable direction is updated according to entrance endpoints of the connecting passages in the initial path, wherein the entrance endpoint of the connecting passage is an exit endpoint of a lane with a predetermined condition in a previous road section of the connecting passage, the lane with a predetermined condition being a lane of which the attribute category is matched with the attribute category of the connecting passage; and a final planed path is generated according to endpoints in the updated initial path.

According to an embodiment of the present disclosure, a path planning device for an unmanned vehicle is provided, which includes: an origin-destination road segment acquisition module, configured to acquire a road segment where an origin of a path is located and a road segment where a destination of the path is located, the road segment including a road section and a connecting passage; an initial path generation module, configured to perform path search to generate an initial path according to a connection relationship between endpoints of road segments, the endpoints of road segments including: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located; an exit endpoint update module, configured to update an exit endpoint of a previous road section of the connecting passages in a passable direction according to entrance endpoints of the connecting passages in the initial path, wherein the entrance endpoint of the connecting passage is an exit endpoint of a lane with a predetermined condition in a previous road section of the connecting passage, the lane with a predetermined condition being a lane of which the attribute category is matched with the attribute category of the connecting passage; and a final path generation module, configured to generate a final planed path according to endpoints in the updated initial path.

According to an embodiment of the present disclosure, a computer-readable storage medium is provided. a computer-executable instruction is stored in the computer-readable storage medium, and the computer-executable instruction is executed by a processor to perform the steps of the path planning method for an unmanned vehicle as mentioned above.

According to an embodiment of the present disclosure, a computer device is provided, and computer device includes a memory and a processor. The memory stores a computer-readable instruction, and the computer-readable instruction is executed by the processor to perform the steps of the path planning method for an unmanned vehicle as mentioned above.

According to the above path planning method and device for an unmanned vehicle, the computer-readable storage medium, and the computer device, an exit endpoint of a previous road section of each connecting passage of a final planned path is an exit endpoint of a lane of which the attribute category is matched with the attribute category of the connecting passage in the road section. It can be seen that when an unmanned vehicle drives in the final generated path, the unmanned vehicle can be driven from a road section to a connecting passage connected thereto through a lane obeying traffic rules. Therefore, the unmanned vehicle is enabled to obey traffic rules and can be driven safely.

### BRIEF DESCRIPTION OF THE DRAWINGS

FIG. 1 is a schematic diagram of a hierarchical structure of a high-precision map in an embodiment;

FIG. 2 is a flowchart of a path planning method for an unmanned vehicle in a construction road segment in an embodiment;

FIG. 3 is a schematic diagram of a road network;

FIG. 4 is a structural schematic diagram of a path planning device for an unmanned vehicle in a construction road segment in an embodiment; and

FIG. 5 is a structural block diagram of a computer device in an embodiment.

### DETAILED DESCRIPTION OF THE EMBODIMENTS

In order to make the purposes, technical solutions and advantages of the present disclosure clearer, the present disclosure will be further described in detail below with reference to the accompanying drawings and embodiments. It is to be understood that the specific embodiments described herein are merely illustrative of the present disclosure and are not intended to limit the present disclosure.

A path planning method for an unmanned vehicle provided by each embodiment of the present application may be applied to a control terminal, where the control terminal may be a mobile terminal or an on-board terminal on an unmanned vehicle. The mobile terminal may specifically be a mobile phone, a tablet computer or a laptop computer.

In a practical application, it is necessary to collect map data and produce a high-precision map before performing the method steps in the embodiments of the present disclosure.

Specifically, a dedicated map data collection vehicle runs in an actual road segment, and a series of road points are surveyed in each road segment to determine geometric parameters of the road segment, so as to collect map data. The road segment may include a road section and a connecting passage, wherein the road section may include a plurality of lanes, and the connecting passage refers to a road segment between two road sections for connecting the two road sections. Based on traffic rules, lanes included in the connecting passage and the road sections have corresponding attribute categories.

Based on the attribute category, the lanes of the road section may include a straight lane, a left-turn lane, a right-turn lane, a U-turn lane, an emergency lane, and the like, It is to be understood that in some road sections, a lane such as a left-turn straight lane may have multiple attribute categories. That is, at an exit endpoint of the lane, a vehicle may either go straight at the interroad segment or turn left at the interroad segment.

In addition, based on the attribute category, the connecting passage may include a cross-track straight connecting passage, an interroad segment straight connecting passage, an interroad segment left-turn connecting passage, an interroad segment right-turn connecting passage, and an interroad segment U-turn connecting passage.

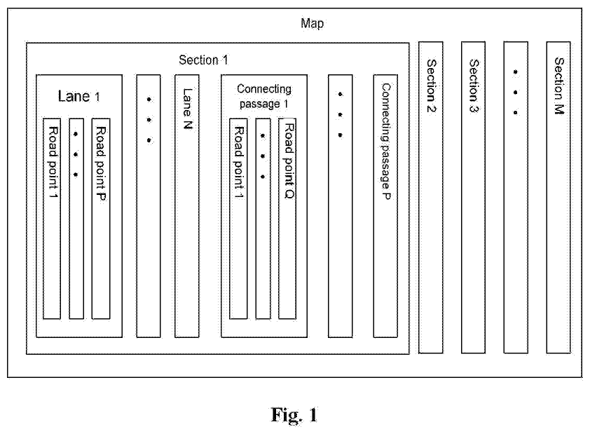

The high-precision map is also involved in the definition of a map data format. Specifically, referring to FIG. 1, the high-precision map data may include a map layer, a road segment layer, a connecting passage layer, a lane layer, and a road point layer. The map layer may include a total number of road segments; the road segment layer may include: a serial number of each road segment, a number of lanes included in each road segment, and a number of connecting passages at an exit of each road segment; the connecting passage layer may include: a serial number of each connecting passage, a serial number of a lane in a road section at an entrance endpoint of each connecting passage, a serial number of a road section at an exit endpoint of each connecting passage, a serial number of a lane in a road section at an exit endpoint of each connecting passage, a category of each connecting passage, and a number of road points included in each connecting passage; the lane layer may include: a serial number of each lane, a width of each lane, a category of each lane, and a number of road points included in each lane; and the road point layer may include: a serial number, longitude and latitude of each road point.

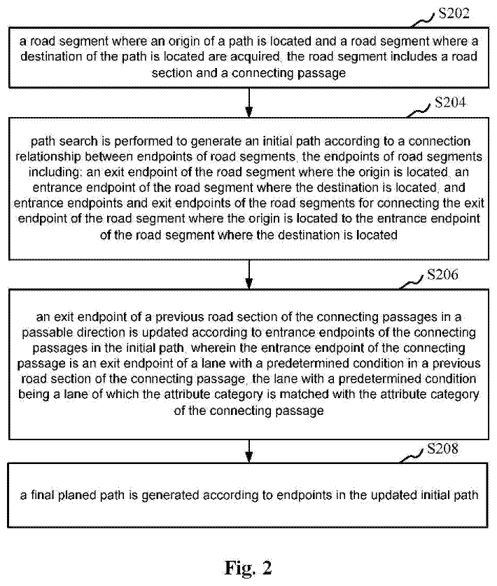

FIG. 2 shows a flowchart of a path planning method for an unmanned vehicle in an embodiment. In the present embodiment, the method is applied to the control terminal described above as an example. Referring to FIG. 2, the method specifically includes step S202 to step S208 as follows.

At step S202, a road segment where an origin of a path is located and a road segment where a destination of the path is located are acquired, the road segment includes a road section and a connecting passage.

The road segment generally refers to a traffic line between two adjacent nodes on a traffic network, and the two nodes are respectively an entrance endpoint and an exit endpoint of the road segment. Specifically, the road segment may include road sections and a connecting passage between two road sections for connecting the two road sections.

It is to be noted that before performing step S202, the origin and destination of a path need to be acquired. The origin and destination of the path may be directly input to the control terminal by a user according to actual needs. Alternatively, the origin of the path may be acquired based on a current location of the present vehicle and a current heading, and the destination of the path may be acquired based on a target position input by the user. In addition, the road segments of the origin and the destination may be determined based on the high-precision map. The origin may be in the road section or in the connecting passage. The destination is similar. No description is repeated herein.

At step S204, path search is performed to generate an initial path according to a connection relationship between endpoints of road segments, the endpoints of road segments including: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located.

It is to be noted that the high-precision map pre-stores connectivity information between the own endpoints of the road segments and connectivity information between the endpoints of each road segment, and connectivity between the own endpoints of the road segments and connectivity between the endpoints of each road segment can be established based on the corresponding connectivity information. For example, in the high-precision map, an entrance endpoint A of a road section. AB and an exit, endpoint B are naturally connected, and the connectivity between the entrance endpoint A and the exit endpoint B may be established based on the connectivity information. In addition, in the high-precision map, an exit endpoint B of a road section AB is an entrance endpoint of a connecting passage BC, and the connectivity between the exit endpoint B of the road section AB and the entrance endpoint of the connecting passage BC may be established based on the connectivity information.

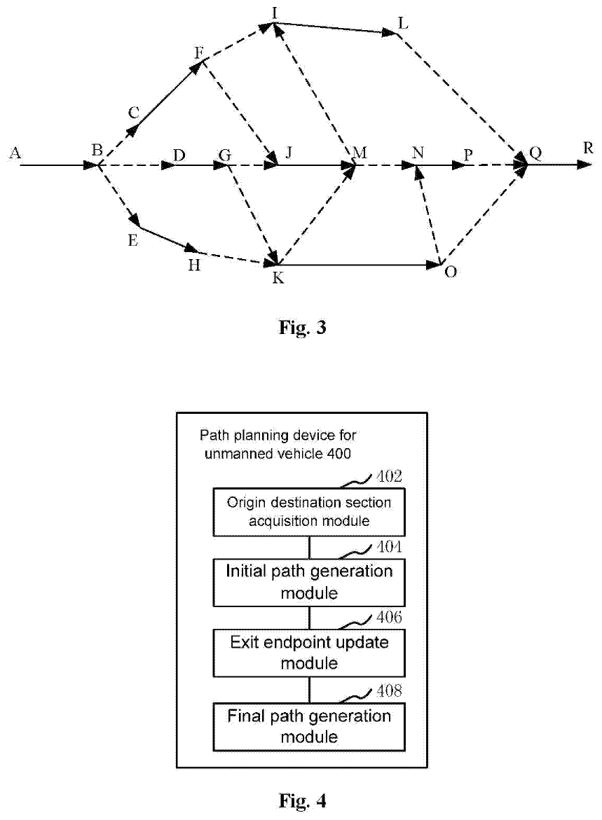

Taking a road network shown in FIG. 3 as an example, it is to be noted that a solid line in FIG. 3 represents a road section, and a broken line represents a connecting passage. The connectivity between endpoints in the road network shown in FIG. 3 is as follows: connecting an endpoint A to an endpoint B, connecting the endpoint B to an endpoint C, connecting the endpoint B to an endpoint D, connecting the endpoint B to an endpoint E, connecting the endpoint C to an endpoint F, connecting the endpoint F to an endpoint I, connecting the endpoint F to an endpoint J, connecting the endpoint I to an endpoint L, connecting the endpoint L to an endpoint Q, connecting the endpoint Q to an endpoint R, connecting the endpoint J to an endpoint M, connecting the endpoint M to an endpoint N, connecting the endpoint M to an endpoint K, connecting the endpoint N to an endpoint P, connecting the endpoint P to the endpoint Q, connecting the endpoint K to an endpoint O, connecting the endpoint O to the endpoint Q, connecting the endpoint O to the endpoint N, connecting the endpoint D to an endpoint G, connecting the endpoint G to the endpoint J, connecting the endpoint G to the endpoint K, connecting the endpoint E to an endpoint H, and connecting the endpoint H to the endpoint K.

In a specific example, based on a connection relationship between endpoints of road segments stored in the high-precision map, accessible road segments for connecting an exit endpoint of a road segment where an origin of a path is located to an entrance endpoint of a road segment where a destination of the path is located can be found to obtain an entrance endpoint and an exit endpoint of each accessible road segment. That is, path search can be performed in the exit endpoint of the road segment where the origin is located, the entrance endpoint of the road segment where the destination is located and the entrance endpoint and the exit endpoint of each accessible road segment, so as to generate an initial path from the origin of the path to the destination.

Taking the road network shown in FIG. 3 as an example, the search starts from the exit, endpoint B of the road segment AB of the origin of the path to obtain all accessible road segments connecting the exit endpoint B and the entrance endpoint Q (such as a road segment BC, a road segment CF, a road segment FI, a road segment IL and a road segment LQ), thereby obtaining the entrance endpoint and the exit endpoint of each accessible road segment (such as the endpoint B, the endpoint C, the endpoint F, the endpoint I, the endpoint L, and the endpoint Q). The path search is performed in the obtained entrance endpoint and exit endpoint of each accessible road segment to generate an initial path from the origin of the path to the destination such as a path B-C-F-I-L-Q. It is to be noted that there are ways to generate the initial path. It is only necessary to ensure that the generated initial path can be from the origin of the path to the destination. For example, a path B-E-H-K-O-Q or a path B-D-G-J-M-N-P-Q, can meet the requirements. No examples will be taken here one by one.

At step S206, an exit endpoint of a previous road section of the connecting passages in a passable direction is updated according to entrance endpoints of the connecting passages in the initial path, wherein the entrance endpoint of the connecting passage is an exit endpoint of a lane with a predetermined condition in a previous road section of the connecting passage, the lane with a predetermined condition being a lane of which the attribute category is matched with the attribute category of the connecting passage.

It is to be noted that the initial path may refer to a path based on road-level planning, that is, an unmanned vehicle may determine a road segment from the origin of the path to the destination according to the initial path, and a positional relationship between the road segments. For example, based on the path B-C-F-I-L-Q-R in FIG. 3, a connecting passage BC, a road segment CF, a connecting passage FI, a road segment IL and a connecting passage LQ can be determined, wherein a previous road section of the connecting passage FI is CF, and a previous road section of the connecting passage LQ is IL. However, it is to be understood that in the initial path, an exit lane where the vehicle needs to drive at the exit endpoint of each road section included in the initial path has not been determined.

In the present embodiment, after the initial path is generated, an exit endpoint of a previous road section of each connecting passage in a passable direction is updated according to an entrance endpoint of each connecting passage included in the initial path. For example, the initial path B-C-F-I-L-Q shown in FIG. 3 includes a road section CF. At, a road segment level, an exit endpoint of the road section CF is F, but refined to a lane level, if the road section CF includes a left-turn lane, a straight lane and a right-turn lane, it is assumed that the exit endpoints of the three lanes are f1, f2 and f3 (not shown) respectively and a connecting passage FI is a left-turn connecting passage, the entrance endpoint of the connecting passage FI is an exit endpoint f1 of the left-turn lane in the previous road section CF in the high-precision map. The exit endpoint of the previous road section CF may be updated from the endpoint F at the road segment level to the endpoint f1 at the lane level based on the entrance endpoint of the connecting passage FI. Similarly, the exit endpoint B of the road section AB may be updated based on the entrance endpoint B of the connecting passage BC, and the exit endpoint L of the road section IL may be updated based on the entrance endpoint L of the connecting passage LQ, which is not described here. At step S208, a final planed path is generated according to endpoints in the updated initial path.

It is to be noted that after the update, the exit endpoints of each road section included in the initial path are the exit endpoints of the lane, and a final planned path can be generated. It is to be understood that the road section and the connecting passage include a plurality of road points in addition to the entrance endpoint and the exit endpoint, so the generated final planned path covers the entrance endpoints, exit endpoints and road points of a plurality of road sections, and the entrance endpoints, exit endpoints and road points of a plurality of connecting passages.

According to the path planning method, an exit endpoint of a previous road section of each connecting passage of a final planned path is an exit endpoint of a lane of which the attribute category is matched with the attribute category of the connecting passage in the road section. It can be seen that when an unmanned vehicle drives in the final generated path, the unmanned vehicle can be driven from a road section to a connecting passage connected thereto through a lane obeying traffic rules. Therefore, the unmanned vehicle is enabled to obey traffic rules and can be driven safely.

In order to further explain the solution of the present disclosure in more detail, some preferred embodiments of the present disclosure are specifically described or exemplified below.

In an embodiment, the manner of acquiring a road segment where an origin of a path is located may includes the following steps: a current location and a current heading of a vehicle are acquired; and a road point which is located within a range where an angle with the current heading is smaller than a preset angle and is closest to the current location is searched, and a road segment where the road point is located is determined as a road segment where an origin of a path is located.

In an embodiment, it is possible to automatically determine a current location of the present vehicle without the manual input of a user, and to detect a current heading of the vehicle (i.e., a current driving direction). Then, the endpoints included in each road section and the endpoints included in each connecting passage are searched based on the high-precision map, and a road segment of an endpoint which is located within a range where an angle with the current heading is smaller than a preset angle and is closest to the current location of the vehicle is determined as the road segment where the origin is located of the path. Preferably, the preset angle may be 90°.

In addition, before determining an endpoint closest to the current location of the vehicle as the origin of the path, it may be judged whether the distance from the endpoint closest to the current location of the vehicle to the current location of the vehicle exceeds a preset distance value. If so, it is indicated that the vehicle is currently on an unknown path and path planning can be stopped. The preset distance value may be set according to an allowable error range of a GPS.

In an embodiment, the manner of acquiring a road segment where a destination of the path is located includes the steps: the information of the destination is acquired; and the road segment of a road point closest to the destination is determined as a road segment where the destination is located.

The destination refers to a position point at which the vehicle needs to arrive. The information of the destination may be manually input to the control terminal by the user. Accordingly, after receiving the information of the destination, the control terminal searches the endpoints included in each road section and the endpoints included in each connecting passage based on the high-precision map, and determines the found road segment of the endpoint closest to the destination as the road segment where the destination is located.

In an embodiment, before a final planed path is generated according to endpoints in the updated initial path, the method further includes the steps as follows.

An entrance endpoint of a lane corresponding to exit endpoints of road sections in the updated initial path is acquired, and the entrance endpoint is updated to an entrance endpoint of each road section in the initial path.

In the present embodiment, for each road section included in the initial path, an entrance endpoint of a lane corresponding to the exit endpoint thereof after update is acquired, and the entrance endpoint is updated to the entrance endpoint thereof. For example, in the initial path B-C-F-I-L-Q shown in FIG. 3, for the road section CF, the entrance endpoints of the left-turn lane, the straight lane and the right-turn lane are c1, c2 and c3, respectively. After the update (after step S206 is performed), the exit endpoint of the road section CF is the exit endpoint f1 of the left-turn lane in the road section CF, so the entrance endpoint c1 of the left-turn lane corresponding to the exit endpoint f1 is acquired, and the exit endpoint of the road section is updated from the endpoint C at the road segment level to the endpoint c1 at the lane level. Similarly, the entrance endpoint A of the road section AB may be updated based on the entrance endpoint B of the connecting passage BC, and the entrance endpoint I of the road section IL may be updated based on the entrance endpoint L of the connecting passage LQ, which is not described here.

In the final planned path generated in the present embodiment, an entrance lane and an exit lane of the road section are the same lane. Based on the final planned path, after driving into a road section during running, an unmanned vehicle may directly exit from the road section through an entrance lane, and there is no need to change lanes midway.

In an embodiment, before a final planed path is generated according to endpoints in the updated initial path, the method further includes the steps as follows:
when it is detected that an entrance lane of any road section in the updated initial path is different from an exit lane, a serial number of the entrance lane and a serial number of the exit lane of the detected road sections are acquired, the entrance lane being a lane corresponding to an entrance endpoint of a road section, and the exit lane being a lane corresponding to an exit endpoint of a road section;
the difference between the serial number of the entrance lane and the serial number of the exit lane of the detected road sections is calculated;
the curvature of each road point in the detected road sections at a location in the detected road sections is acquired; and
the Lane-changing road points of which the quantity is equal to the difference in road points in the detected road sections are determined according to the curvature of each road point in the detected road sections.
the step of generating a final planed path according to endpoints in the updated initial path includes: the final planed path is generated according to the lane-changing road points and endpoints in the updated initial path.

It is to be noted that if it is detected that an entrance endpoint and an exit endpoint of a road section in the initial path are not in the same lane based on the high-precision map, that is, an entrance lane and an exit lane of a road section are not the same lane, a difference between a serial number of a lane where the entrance endpoint of the road section is located and a serial number of a lane where the exit endpoint is located needs to be calculated, and lane-changing road points of which the quantity is, equal to the difference are determined in the road section to plan a final planned path passing through different lanes gradually in a corresponding road section, so as to ensure that a vehicle can be piloted off the corresponding road section from a set exit lane.

In the present embodiment, lane-changing road points can be determined according to a curvature of each road point included in a road section at a location in the road section. Specifically, a road point with a larger curvature can be avoided, and a road point with a smaller curvature can be selected as a lane-changing road point to provide the lane-changing road point in a straight road section. In addition, there may be sufficient spacing between adjacent two lane-changing road points.

In an embodiment, the step of performing path search to generate an initial path according to a connection relationship between endpoints of road segments includes: a path search is performed to generate an initial path according to a connection relationship between endpoints of road segments and an A-star algorithm.

In the present embodiment, the A-star algorithm is used for path search. In the path search process, a total cost value of a current endpoint is calculated by the following formula:

f(t)=g(t)+h(t)

where f(t) is a total cost value of a current endpoint; g(t) is an actual path cumulative distance cost from an origin to the current endpoint; and h(t) is an estimated distance cost of the current endpoint to a destination.

In a specific example, the estimated distance cost may be the Manhattan distance cost, that is, the sum of absolute value of a longitude distance difference and a latitude distance difference between the current endpoint and the destination, and the Manhattan distance can be used for simple and rapid estimation. In addition, the estimated distance cost may also be a Euclidean distance cost or a diagonal line cost, etc., and is not specifically limited herein.

Next, taking the road network shown in FIG. 3 as an example, a process of performing path search based on the A-star algorithm will be described.

First, an open table and a closed table are set. An endpoint B is directly added to the closed table, starting searching from the endpoint B, all endpoints (endpoint C, endpoint D and endpoint E) connected to the endpoint B are added to the open table, and the endpoint B is set as a parent node of the endpoint C, the endpoint D and the endpoint E; total cost values of the endpoint C, the endpoint D and the endpoint E in the open table are calculated respectively. It is assumed that among the three endpoints, the total cost value of the endpoint C is minimum, and the total cost value of the endpoint E is maximum.

The endpoint C with the minimum current total cost value in the open table is removed from the open table, and added to the closed table. Then, all endpoints connected to the endpoint C but not in the closed table are investigated, that is, an endpoint F; the endpoint C is set as a parent node of the endpoint F, a total cost value of the endpoint F is calculated, and the endpoint F is added to the open table. It is assumed that the total cost value of the endpoint F is greater than the total cost values of the endpoint D and the endpoint E.

The endpoint D with the minimum current total cost value in the open table is removed from the open table, and added to the closed table. Then, all endpoints connected to the endpoint D but not in the closed table are investigated, that is, an endpoint G; the endpoint D is set as a parent node of the endpoint G, a total cost value of the endpoint G is calculated, and the endpoint G is added to the open table. It is assumed that the total cost value of the endpoint G is greater than the total cost values of the endpoint E and the endpoint F.

The endpoint E with the minimum current total cost value in the open table is removed from the open table, and added to the closed table. Then, all endpoints connected to the endpoint E but not in the closed table are investigated, that is, an endpoint H; the endpoint E is set as a parent node of the endpoint H, a total cost value of the endpoint H is calculated, and the endpoint H is added to the open table. It is assumed that the total cost value of the endpoint H is greater than the total cost values of the endpoint F and the endpoint G.

The endpoint F with the minimum current total cost value in the open table is removed from the open table, and added to the closed table. Then, all endpoints connected to the endpoint F but not in the closed table are investigated, that is, an endpoint I and an endpoint J; the endpoint F is set as a parent node of the endpoint and the endpoint J, total cost values of the endpoint I and the endpoint J are calculated respectively, and the endpoint I and the endpoint J are added to the open table. It is assumed that the total cost value of the endpoint J is greater than the total cost value of the endpoint I, and the total cost value of the endpoint I is greater than the total cost values of the endpoint F and the endpoint G.

The endpoint G with the minimum current total cost value in the open table is removed from the open table, and added to the closed table. Then, all endpoints connected to the endpoint G but not in the closed table are investigated, that is, an endpoint J and an endpoint K. For the endpoint K that is neither in the open table nor in the closed table, the endpoint G is set as its parent node, a total cost value of the endpoint K is calculated, and the endpoint K is added to the open table; for the endpoint J that is already in the open table, a g(t) value calculated based on a path G-J with a g(t) value previously calculated based on a path F-J, if the g(t) value calculated based on the path G-J is smaller than the g(t) calculated based on the path F-J, the parent node of the endpoint J is modified from the endpoint F to the endpoint G, and the total cost value of the endpoint J is updated according to the g(t) value calculated based on the path G-J.

According to the same operations above, and so on, until an endpoint Q is added to the closed table. At this time, the parent node is searched sequentially from the endpoint Q, and a shortest path from the endpoint B to the endpoint Q can be obtained; if the open table is already empty and the endpoint Q is not added to the closed table, it is indicated that a path from the endpoint B to the endpoint Q cannot be planned, so that path planning is stopped.

In addition, the A-star algorithm is a path search algorithm based on the shortest path principle. Therefore, the present embodiment can obtain a shortest path from the origin of the path to the destination.

FIG. 4 shows a structural schematic diagram of a path planning device for an unmanned vehicle in an embodiment. Referring to FIG. 4, the device 400 specifically includes an origin-destination road segment acquisition module 402, an initial path generation module 404, an exit endpoint update module 406, and a final path generation module 408.

The origin-destination road segment acquisition module 402 is configured to acquire a road segment where an origin of a path is located and a road segment where a destination of the path is located, the road segment including a road section and a connecting passage.

The initial path generation module 404 is configured to perform path search to generate an initial path according to a connection relationship between endpoints of road segments, the endpoints of road segments including: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located.

The exit endpoint update module 406 is configured to update an exit endpoint of a previous road section of the connecting passages in a passable direction according to entrance endpoints of the connecting passages in the initial path, wherein the entrance endpoint of the connecting passage is an exit endpoint of a lane with a predetermined condition in a previous road section of the connecting passage, the lane with a predetermined condition being a lane of which the attribute category is matched with the attribute category of the connecting passage.

The final path generation module 408 is configured to generate a final planed path according to endpoints in the updated initial path.

According to the path planning device for an unmanned vehicle, an exit endpoint of a previous road section of each connecting passage of a final planned path is an exit endpoint of a lane of which the attribute category is matched with the attribute category of the connecting passage in the road section. It can be seen that when an unmanned vehicle drives in the final generated path, the unmanned vehicle can be driven from a road section to a connecting passage connected thereto through a lane obeying traffic rules. Therefore, the unmanned vehicle is enabled to obey traffic rules and can be driven safely.

In an embodiment, the origin-destination road segment acquisition module 402 includes a real vehicle condition acquisition unit and an origin road segment determination module.

The real vehicle condition acquisition unit is configured to acquire a current location and a current heading of a vehicle.

The origin road segment determination module is configured to search for a road point which is located within a range where an angle with the current heading is smaller than a preset angle and is closest to the current location, and determine a road segment where the road point is located as a road segment where an origin of a path is located.

In an embodiment, the origin-destination road segment acquisition module 402 includes a destination information acquisition unit and a destination road segment determination module.

The destination information acquisition unit is configured to acquire information of the destination.

The destination road segment determination module is configured to determine a road segment where a road point closest to the destination is located as a road segment where the destination is located.

In an embodiment, the device 400 further includes an entrance endpoint update module.

The entrance endpoint update module is configured to acquire an entrance endpoint of a lane corresponding to exit endpoints of road sections in the updated initial path, and update the entrance endpoint to an entrance endpoint of each road section in the initial path.

In an embodiment, the device 400 further includes a lane serial number acquisition module, a serial number difference calculation module, a curvature acquisition module, and a lane-changing road point determination module.

The lane serial number acquisition module is configured to acquire, when it is detected that an entrance lane of any road section in the updated initial path is different from an exit lane, a serial number of the entrance lane and a serial number of the exit lane, of the detected road sections, the entrance lane being a lane corresponding to an entrance endpoint of a road section, and the exit lane being a lane corresponding to an exit endpoint of a road section.

The serial number difference calculation module is configured to calculate a difference between the serial number of the entrance lane and the serial number of the exit lane of the detected road sections.

The curvature acquisition module is configured to acquire a curvature of each road point in the detected road sections at a location in the detected road sections.

The lane-changing road point determination module is configured to determine lane-changing road points of which the quantity is equal to the difference in road points in the detected road sections according to the curvature of each road point in the detected road sections.

The final path generation module 408 is configured to generate a final planed path according to the lane-changing road points and endpoints in the updated initial path.

Other technical features in the path planning device for an unmanned vehicle of the present embodiment may be the same as those in the embodiment of the path planning method for an unmanned vehicle.

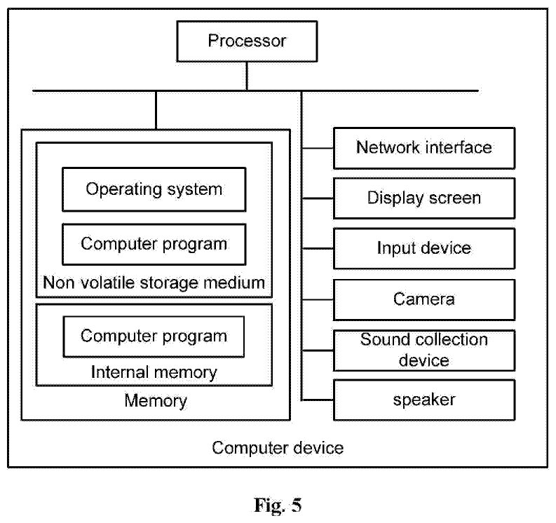

FIG. 5 shows an internal structure diagram of a computer device in an embodiment. The computer device may specifically be the control terminal mentioned above. As shown in FIG. 5, the computer device may include a processor, a memory, a network interface, an input device and a display screen connected by a system bus. The memory includes a non-volatile storage medium and an internal memory. The non-volatile storage medium of the computer device stores an operating system and may also store a computer program. When the computer program is executed by a processor, the processor is enabled to implement the path planning method for an unmanned vehicle. The internal memory may further store a computer program. When the computer program is executed by a processor, the processor is enabled to execute the path planning method for an unmanned vehicle. The display screen of the computer device may be a liquid crystal display screen or an electronic ink display screen, and the input device of the computer device may be a touch layer covered on the display screen, or a button, a trackball or a touchpad provided on a housing of the computer device, or may be an external keyboard, a touchpad or a mouse.

It will be understood by those skilled in the art that the structure shown in FIG. 5 is only a block diagram of a part of the structure related to the solution of the present application, and does not constitute a limitation of the computer device to which the solution of the present application is applied. The specific computer device may include more or fewer components than those shown in the figures, or combine some components, or have different component arrangements.

In an embodiment, the path planning device for an unmanned vehicle provided by the present disclosure may be implemented in the form of a computer program that may be run on the computer device as shown in FIG. 5. The memory of the computer device may store program modules forming the path planning device for an unmanned vehicle such as the origin-destination road segment acquisition module 402, the initial path generation module 404, the exit endpoint, update module 406, and the final path generation module 408 as shown in FIG. 4. The computer program of each program module causes the processor to perform the steps in the path planning method for an unmanned vehicle of embodiments of the present application described in the present specification.

For example, the computer device shown in FIG. 5 may perform step S202 in FIG. 2 via the origin-destination road segment acquisition module 402 in the path planning device for an unmanned vehicle as shown in FIG. 4, perform step S204 in FIG. 2 via the initial path generation module 404, perform step S206 in FIG. 2 via the exit endpoint update module 406, and perform step S208 in FIG. 2 via the final path generation module 408.

For this purpose, a computer device is also provided in an embodiment. The computer device includes a memory and a processor, the memory storing a computer-readable instruction, wherein when the computer-readable instruction is executed by the processor, the processor is enabled to perform the steps of the path planning method for an unmanned vehicle in any embodiment provided by the present application.

According to the computer device, an exit endpoint of a previous road section of each connecting passage of a final planned path is an exit endpoint of a lane of which the attribute category is matched with the attribute category of the connecting passage in the road section. It can be seen that when an unmanned vehicle drives in the final generated path, the unmanned vehicle can be driven from a road section to a connecting passage connected thereto through a lane obeying traffic rules. Therefore, the unmanned vehicle is enabled to obey traffic rules and can be driven safely.

Those skilled in the art can understand that all or part of the processes in the above method embodiments may be implemented by a computer program to instruct related hardware, and the program may be stored in a nonvolatile computer-readable storage medium. When the program is executed, the flow of each method embodiment as described above may be included. Any reference to a memory, storage, database, or other media used in embodiments provided by the present application may include nonvolatile and/or volatile memories. The nonvolatile memory may include a Read Only Memory (ROM), a Programmable ROM (PROM), an Electrically Programmable ROM (EPROM), an Electrically Erasable Programmable ROM (EEPROM), or a flash memory. The volatile memory may include a Random Access Memory (RAM) or an external cache memory. By way of illustration and not limitation, RAM is available in a variety of formats, such as a Static RAM (SRAM), a Dynamic RAM (DRAM), a Synchronous DRAM (SDRAM), a Dual Data Rate SDRAM (DDRSDRAM), an Enhanced SDRAM (ESDRAM), a Synchlink DRAM (SLDRAM), a Rambus Direct RAM (RDRAM), a Direct Rambus Dynamic RAM (DRDRAM), and a Rambus Dynamic RAM (RDRAM).

For this purpose, a computer-readable storage medium is also provided in an embodiment. The computer-readable storage medium has a computer-executable instruction stored thereon. When the computer-executable instruction is executed by a processor, the processor is enabled to perform the steps of the path planning method for an unmanned vehicle in any embodiment provided by the present application.

According to the computer-readable storage medium, an exit endpoint of a previous road section of each connecting passage of a final planned path is an exit endpoint of a lane of which the attribute category is matched with the attribute category of the connecting passage in the road section. It can be seen that when an unmanned vehicle drives in the final generated path, the unmanned vehicle can be driven from a road section to a connecting passage connected thereto through a lane obeying traffic rules. Therefore, the unmanned vehicle is enabled to obey traffic rules and can be driven safely.

The technical features of the above embodiments may be arbitrarily combined. For the sake of brevity of description, all possible combinations of the technical features in the above embodiments are not described. However, as long as there is no contradiction in the combination of these technical features, it is considered to be the, range described in this specification.

The above embodiments are merely illustrative of several implementation manners of the present application with specific and detailed description, and are not to be construed as limiting the patent scope of the present application. It is to be noted that a number of variations and modifications may be made by those of ordinary skill in the art without departing from the conception of the present application, and all fall within the scope of protection of the present application. Therefore, the scope of protection of the present application should be determined by the appended claims.

1. A path planning method for an unmanned vehicle, comprising:
acquiring a road segment where an origin of a path is located and a road segment where a destination of the path is located, the road segment comprising a road section and a connecting passage;
performing path search to generate an initial path according to a connection relationship between endpoints of road segments, the endpoints of road segments comprising: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located;
updating an exit endpoint of a previous road section of the connecting passages in a passable direction according to entrance endpoints of the connecting passages in the initial path, wherein the entrance endpoint of the connecting passage is an exit endpoint of a lane with a predetermined condition in a previous road section of the connecting passage in a passable direction, the lane with a predetermined condition being a lane of which the attribute category is matched with the attribute category of the connecting passage; and
generating a final planed path according to endpoints in the updated initial path.

2. The path planning method for an unmanned vehicle as claimed in claim 1, wherein the manner of acquiring a road segment where an origin of a path is located comprises:
acquiring a current location and a current heading of a vehicle; and
searching for a road point which is located within a range where an angle with the current heading is smaller than a preset angle and is closest to the current location, and determining a road segment where the road point is located as a road segment where an origin of a path is located.

3. The path planning method for an unmanned vehicle as claimed in claim 1, wherein the manner of acquiring a road segment where a destination of the path is located comprises:
acquiring information of the destination; and
determining a road segment where, a road point closest to the destination is located as a road segment where the destination is located.

4. The path planning method for an unmanned vehicle as claimed in claim 1, wherein before generating a final planed path according to endpoints in the updated initial path, the method further comprises:
acquiring an entrance endpoint of a lane corresponding to exit endpoints of road sections in the updated initial path, and updating the entrance endpoint to an entrance endpoint of each of the road sections in the initial path.

5. The path planning method for an unmanned vehicle as claimed in claim 1, wherein before generating a final planed path according to endpoints in the updated initial path, the method further comprises:
acquiring, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint of a road, section;
calculating a difference between the serial number of the entrance lane and the serial number of the exit lane of the detected road sections;
acquiring a curvature of each road point in the detected road sections at a location in the detected road sections; and
determining lane-changing road points of which the quantity is equal to the difference in road points in the detected road sections according to the curvature of each road point in the detected road sections;
generating a final planed path according to endpoints in the updated initial path comprises:
generating a final planed path according to the lane-changing road points and endpoints in the updated initial path.

6. A path planning device for an unmanned vehicle, comprising:
an origin-destination road segment acquisition module, configured to acquire a road segment where an origin of a path is located and a road segment where a destination of the path is located, the road segment comprising, a road section and a connecting passage;
an initial path generation module, configured to perform path search to generate an initial path according to a connection relationship between endpoints of road segments, the endpoints of road segments comprising: an exit endpoint of the road segment where the origin is located, an entrance endpoint of the road segment where the destination is located, and entrance endpoints and exit endpoints of the road segments for connecting the exit endpoint of the road segment where the origin is located to the entrance endpoint of the road segment where the destination is located;
an exit endpoint update module, configured to update an exit endpoint of a previous road section of the connecting passages in a passable direction according to entrance endpoints of the connecting passages in the initial path, wherein the entrance endpoint of the connecting passage is an exit endpoint of a lane with a predetermined condition in a previous road section of the connecting passage, the lane with a predetermined condition being a lane of which the attribute category is matched with the attribute category of the connecting passage; and
a final path generation module, configured to generate a final planed path according to endpoints in the updated initial path.

7. The path planning device for an unmanned vehicle as claimed in claim 6, further comprising:
an entrance endpoint update module, configured to acquire an entrance endpoint of a lane corresponding to exit endpoints of road sections in the updated initial path, and update the entrance endpoint to an entrance endpoint of each road section in the initial path.

8. The path planning device for an unmanned vehicle as claimed in claim 6, further comprising:
a lane serial number acquisition module, configured to acquire, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint of a road section;
a serial number difference calculation module, configured to calculate a difference between the serial number of the entrance lane and the serial number of the exit lane of the detected road sections;
a curvature acquisition module, configured to acquire a curvature of each road point in the detected road sections at a location in the detected road sections; and
a lane-changing road point determination module, configured to determine lane-changing road points of which the quantity is equal to the difference in road points in the detected road sections according to the curvature of each road point in the detected road sections,
wherein the final path generation module is configured to:
generate a final planed path according to the lane-changing road points and endpoints in the updated initial path.

9. A computer-readable storage medium, having a computer-executable instruction stored thereon, wherein when the computer-executable instruction is executed by a processor, the processor is enabled to perform the steps of the method as claimed in claim 1.

10. A computer device, comprising a memory and a processor, the memory storing a computer-readable instruction, wherein when the computer-readable instruction is executed by the processor, the processor is enabled to perform the steps of the method as claimed in claim 1.

11. The path planning method for an unmanned vehicle as claimed in claim 2, wherein before generating a final planed path according to endpoints in the updated initial path, the method further comprises:
acquiring, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint of a road section;
calculating a difference between the serial number of the entrance lane and the serial number of the exit lane of the detected road sections;
acquiring a curvature of each road point in the detected road sections at a location in the detected road sections; and
determining lane-changing road points of which the quantity is equal to the difference in road points in the detected road sections according to the curvature of each road point in the detected road sections;
generating a final, planed path according to endpoints in the updated initial path comprises:
generating a final planed path according to the lane-changing road points and endpoints in the updated initial path.

12. The path planning method for an unmanned vehicle as claimed in claim 3, wherein before generating a final planed path according to endpoints in the updated initial path, the method further comprises:
acquiring, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint of a road section;
calculating a difference between the serial number of the entrance lane and the serial number of the exit lane of the detected road sections;
acquiring a curvature of each road point in the detected road sections at a location in the detected road sections; and
determining lane-changing road points of which the quantity is equal to the difference in road points in the detected road sections according to the curvature of each road point in the detected road sections;
generating a final planed path according to endpoints in the updated initial path comprises:
generating a final planed path according to the lane-changing road points and endpoints in the updated initial path.

13. The path planning method for an unmanned vehicle as claimed in claim 4, wherein before generating a final planed path according to endpoints in the updated initial path, the method further comprises:
acquiring, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint of a road section;
calculating a difference between the serial number of the entrance lane and the serial number of the exit lane of the detected road sections;
acquiring a curvature of each road point in the detected road sections at a location in the detected road sections; and
determining lane-changing road points of which the quantity is equal to the difference in road points in the detected road sections according to the curvature of each road point in the detected road sections;
generating a final planed path according to endpoints in the updated initial path comprises:
generating a final planed path according to the lane-changing road points and endpoints in the updated initial path.

14. The path planning device for an unmanned vehicle as claimed in claim 7, further comprising:
a lane serial number acquisition module, configured to acquire, when it is detected that an entrance lane of any road section in the updated initial path is different from an exit lane, a serial number of the entrance lane and a serial number of the exit lane of the detected road sections, the entrance lane being a lane corresponding to an entrance endpoint of a road section, and the exit lane being a lane corresponding to an exit endpoint, of a road section;
a serial number difference calculation module, configured to calculate a difference between the serial number of the entrance lane and the serial number of the exit lane of the detected road sections;
a curvature acquisition module, configured to acquire a curvature of each road point in the detected road sections at a location in the detected road sections; and
a lane-changing road point determination module, configured to determine lane-changing road points of which the quantity is equal to the difference in road points in the detected road sections according to the curvature of each road point in the detected road sections,
wherein the final path generation module is configured to:
generate a final planed path according to the lane-changing road points and endpoints in the updated initial path.

15. The path planning device for an unmanned vehicle as claimed in claim 6, wherein the origin-destination road segment acquisition module acquires the road segment where the origin of a path is located in the following manner:
acquiring a current location and a current heading of a vehicle; and
searching for a road point which is located within a range where an angle with the current heading is smaller than a preset angle and is closest to the current location, and determining a road segment where the road point is located as a road segment where an origin of a path, is located.

16. The path planning device for an unmanned vehicle as claimed in claim 6, wherein the origin-destination road segment acquisition module acquires the road segment where the destination of the path is located in the following manner:
acquiring information of the destination; and
determining a road segment where a road point closest to the destination is located as a road segment where the destination is located.
